(19) United States
(12) Patent Application Publication
(10) Pub. No.: US 2003/0101463 A1
(43) Pub. Date: May 29, 2003

(54) Passive CMTS redundancy

(75) Inventors: Clarke V. Greene, Middletown, CT (US); J. David Unger, Windham, NH (US); Andrew R. Boyce, Bolton, MA (US)

Correspondence Address: Fogg. Slifer & Polglaze, P.A., P.O. Box 581009, Minneapolis, MN, 55458-1009, US

(73) Assignee: ADC Telecommunications, Inc.

(21) Appl. No.: 09/995,167

(22) Filed: Nov. 26, 2001

(51) Int. Cl. H04N 7/173

(52) U.S. Cl. 725/111; 725/112; 725/114

(57) ABSTRACT

Cable modem termination systems (CMTS) having directional couplers in the primary signal path facilitate redundancy without the need for active components, e.g., switches or amplifiers, in the primary signal path. The use of directional couplers in the primary signal path allows a backup CMTS transceiver to provide redundancy to multiple primary CMTS transceivers through the use of switching outside of the primary signal path. Additional directional couplers in the backup signal path may be used to allow testing and maintenance of the backup CMTS transceiver without disturbing the primary signal path.

### TECHNICAL FIELD OF THE INVENTION

The present invention relates generally to telecommunications, and in particular to apparatus and methods to facilitate redundancy for cable modem termination systems (CMTS).

### BACKGROUND OF THE INVENTION

Coaxial cable networks have been used to deliver high quality video programming to subscribers for many years. Conventionally, these networks have been unidirectional, broadcast networks with a limited number of channels and a limited variety of content provided to the subscribers. In recent years, cable companies have developed systems to provide bi-directional communication over their existing networks to provide a wider variety of services and content to their subscribers. For example, many cable companies now provide connection to the Internet through the use of cable modems.

The cable industry has developed a number of standards for delivering data over their networks to provide a uniform basis for the design and development of the equipment necessary to support these services. For example, a consortium of cable companies developed the Data Over Cable Service Interface Specifications (DOCSIS) standard. The DOCSIS standard specifies the necessary interfaces to allow for transparent, bi-directional transfer of Internet Protocol (IP) traffic between a cable head end and customer equipment over a cable network, such as a coaxial cable network or hybrid fiber/coax (HFC) network.

A cable modem termination system (CMTS) is included in the head end of the cable network for processing the upstream and downstream transmission of data. In the upstream, the CMTS down converts data signals from cable modems to base band or a low intermediate frequency. The CMTS then demodulates the signals and provides the data to a network, e.g., the Internet. In the downstream, the CMTS receives data for a plurality of modems at a network interface. The CMTS modulates a carrier with this data and transmits it downstream over a shared medium to the plurality of modems.

System availability is important to consumers and other users of the cable network. Systems supporting lifeline and primary-line telephone services, for example, require very high system availability. As with many electronic systems, device redundancy is often used to improve the availability of a cable network. Some redundancy systems use a backup CMTS transceiver for every primary CMTS transceiver in a one-to-one relationship. While effective, this method if costly because the number of backup CMTS transceivers is equal to the number of primary CMTS transceivers. Other redundancy systems have used switches in the signal path of the primary CMTS transceivers to permit switching between a one or more primary CMTS transceivers and a backup CMTS transceiver. However, these switches are a potential source of failure. Also, having a switch in the primary signal path requires that the primary system be taken off line in order to replace a failed switch. This is highly undesirable. Further redundancy systems have used passive combiners in the signal path of the primary CMTS transceivers to connect to a backup CMTS transceiver. Passive combiners incur significant signal loss to the primary CMTS signals, often more than 3.5 dB. This requires the transmit stages in the primary CMTS transceivers to run at a higher level to provide the necessary system signal levels, thus requiring more expensive amplifiers, higher power usage and higher heat generation. In addition, unless extra circuitry is added to switch in terminations to unconnected combiner ports, the return loss (which corresponds to the impedance mismatch in a 75 ohm system) presented to the cable plant is very poor. This adds switching into the primary CMTS transceiver signal paths, thus reducing the system reliability.

For the reasons stated above, and for other reasons stated below that will become apparent to those skilled in the art upon reading and understanding the present specification, there is a need in the art for alternative apparatus and methods for increasing availability of network services.

### SUMMARY

Cable modem termination systems (CMTS) having directional couplers in the primary signal path facilitate redundancy without the need for active components, e.g., switches, in the primary signal path. The use of directional couplers in the primary signal path allows a backup CMTS transceiver to provide redundancy to multiple primary CMTS transceivers through the use of switching outside of the primary signal path. Additional directional couplers in the backup signal path may be used to allow testing and maintenance of the backup CMTS transceiver without disturbing the primary signal path.

For one embodiment, the invention provides a cable modem termination system (CMTS). The CMTS includes two or more primary CMTS transceivers, each for transceiving communications through a primary signal path, and a plurality of directional couplers connected to the primary CMTS transceivers in the primary signal path. The CMTS further includes one backup CMTS transceiver selectively connected to the plurality of directional couplers outside of the primary signal path.

For another embodiment, the invention provides a redundancy system for a CMTS. The system includes a first directional coupler comprising a first port for connecting to a communication line, a second port connected to a first CMTS transceiver for transceiving communications on the communication line in a first operation mode and a third port selectively connected to a backup CMTS transceiver for transceiving communication on the communication line in a second operation mode.

For yet another embodiment, the invention provides a CMTS. The CMTS includes at least one primary CMTS transceiver, each primary CMTS transceiver comprising one or more upstream communication ports for transceiving communications with subscriber equipment and one or more downstream communication ports for transceiving communications with a head end. The CMTS further includes at least one backup CMTS transceiver, each backup CMTS transceiver comprising one or more upstream communication ports for transceiving communications with the subscriber equipment and one or more downstream communication ports for transceiving communications with the head end. The CMTS still further includes a plurality of directional couplers, with a directional coupler connected to each communication port of the primary CMTS transceivers. Each communication port of a backup CMTS transceiver is selectively connected to a directional coupler of a corresponding communication port of at least one primary CMTS transceiver.

For a further embodiment, the invention provides a method of providing redundancy in a CMTS. The method includes passing communications through a directional coupler to a primary CMTS transceiver during a first operation mode and passing the communications through the directional coupler to a backup CMTS transceiver during a second operation mode.

For a still further embodiment, the invention provides a method of operating a CMTS. The method includes communicating with one or more primary CMTS transceivers across a primary signal path during a first operation mode, wherein each primary CMTS transceiver has one or more upstream communication ports for communication with subscriber equipment and one or more downstream communication ports for communication with a head end, and wherein a directional coupler is connected between each upstream communication port and the subscriber equipment and between each downstream communication port and the head end. The method further includes detecting a failure of one of the primary CMTS transceivers and entering a second operation mode wherein communication with the failed primary CMTS transceiver is routed through a backup CMTS transceiver through the directional couplers associated with the failed primary CMTS transceiver.

Further embodiments of the invention include apparatus and methods of varying scope.

### BRIEF DESCRIPTION OF THE DRAWINGS

FIG. 1 is a schematic of a communications network in accordance with an embodiment of the invention.

FIG. 2 is a schematic of a cable modem termination system (CMTS) in accordance with an embodiment of the invention.

FIG. 3 is a schematic showing detail of a primary CMTS transceiver and an associated interface adapter in accordance with an embodiment of the invention.

FIGS. 4A-4B are schematics of an upstream switch module including optional directional couplers and pilot tone generator for use in testing of the CMTS in accordance with an embodiment of the invention.

FIGS. 5A-5B are schematics of a downstream switch module including optional directional couplers and RF level detector for use in testing of the CMTS in accordance with an embodiment of the invention.

FIG. 6 is a block diagram of a CMTS showing connectivity of various components in accordance with an embodiment of the invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

The various embodiments facilitate passive redundancy for cable modem termination systems (CMTS). The various embodiments further facilitate elimination of the use of switches or any active components in the primary signal path that can reduce the reliability of the system. In addition, such a passive approach allows replacement of a defective primary CMTS transceiver without interrupting service to the customer network through the backup, or redundant, CMTS transceiver.

Various embodiments utilize directional couplers in the primary signal path for each CMTS transceiver to be backed up. Signals sent between subscriber equipment and the primary CMTS transceivers pass through directional couplers with relatively low loss. Signals associated with a failed primary CMTS transceiver are selectively routed through a backup CMTS transceiver outside of the primary signal path.

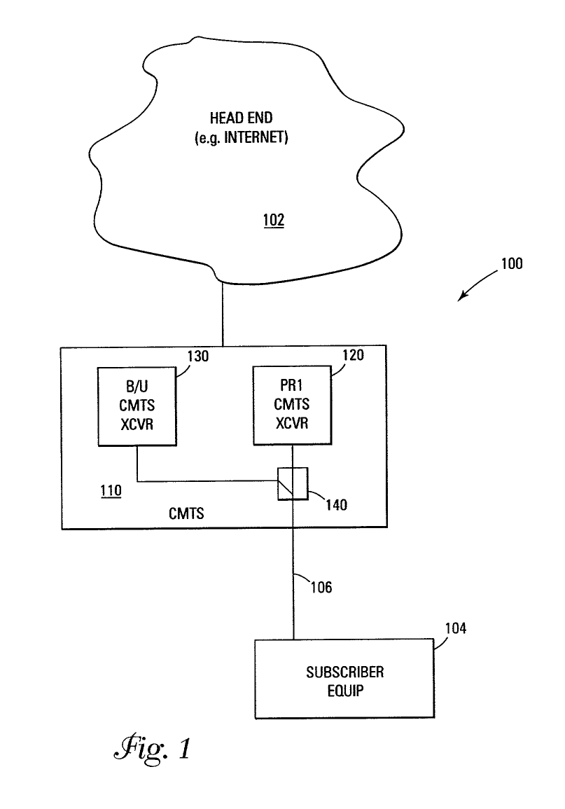

FIG. 1 is a schematic of a communications network 100 in accordance with an embodiment of the invention. The communications network 100 carries communication signals between a head end 102, e.g., the Internet, and subscriber equipment 104, e.g., cable modems, through an access network 106, e.g., a coaxial cable network or hybrid fiber/coax (HFC) network using the Data Over Cable Service Interface Specifications (DOCSIS) standard.

Communication signals between the head end 102 and the subscriber equipment 104 is facilitated through a cable modem termination system (CMTS) 110 connected between the access network 106 and the head end 102. As used herein, the term “connected” in its various forms refers to establishing an ability to convey communication signals and does not require a direct physical or electrical connection.

The CMTS 110 includes at least one primary CMTS transceiver 120 and at least one backup CMTS transceiver 130. While the ratio of primary CMTS transceivers 120 to backup CMTS transceivers 130 is not limited by the invention, it is typically preferred to have some ratio greater than one. For one embodiment, there is one backup CMTS transceiver 130 for every six primary CMTS transceivers 120. For another embodiment, there is one backup CMTS transceiver 130 for every ten primary CMTS transceivers 120.

Passive directional couplers 140 are connected between the access network 106 and the primary CMTS transceivers. In a similar fashion, further directional couplers (not shown in FIG. 1 for clarity) are connected between the head end 102 and the primary CMTS transceivers 120. The directional couplers 140 are configured to incur relatively low loss in the primary signal path, i.e., the path between the head end 102 and the subscriber equipment 104 through the primary CMTS transceivers 120, yet permit a portion of the signal to pass to the backup CMTS transceiver 130. The use of passive devices such as the directional couplers 140 permit switching to the backup CMTS transceiver 130 without having an active switching device in the primary signal path.

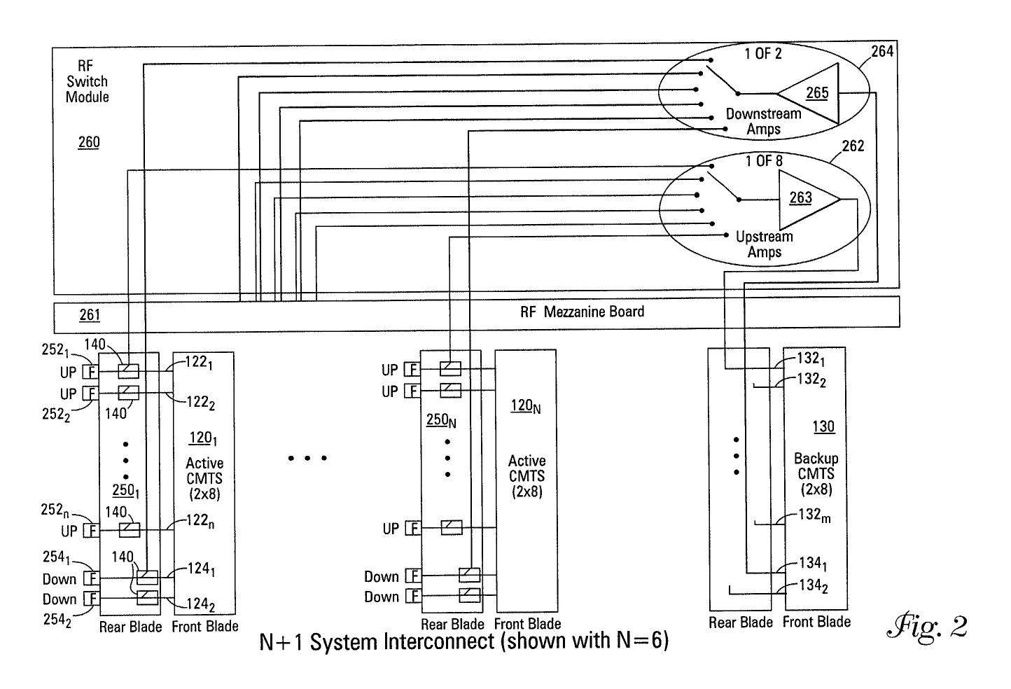

FIG. 2 is a schematic of a CMTS 110 in accordance with an embodiment of the invention. The CMTS 110 includes a plurality of active or primary CMTS transceivers 120₁-120_{N} for every one backup CMTS transceiver 130. Each primary CMTS transceiver 120 has a number of communication ports. Similarly, each backup CMTS transceiver 130 has a number of communication ports. As used herein, communication ports for connecting to the subscriber equipment 104 will be termed upstream communication ports and communication ports for connecting to the head end 102 will be termed downstream communication ports.

Upstream communication ports for primary CMTS transceivers are designated as reference numbers 122₁-122ₙ in FIG. 2 while upstream communication ports for backup CMTS transceivers are designated as reference numbers 132₁-132ₘ in FIG. 2. Similarly, downstream communication ports for primary CMTS transceivers are designated as reference numbers 122₁-124₂ in FIG. 2 while downstream communication ports for backup CMTS transceivers are designated as reference numbers 132₁-134₂ in FIG. 2. While only two downstream communication ports are depicted for each CMTS transceiver, there is no such limitation.

In general, each CMTS transceiver has one or more upstream communication ports and one or more downstream communication ports. A CMTS transceiver will typically have more upstream communication ports than downstream communication ports. However, such is not required. For one embodiment, each CMTS transceiver has eight upstream communication ports and two downstream communication ports. For ease of implementation and inventory, it is preferable that backup CMTS transceivers are either similarly configured, containing a corresponding communication port for each communication port of the primary CMTS transceivers for which it provides redundancy, or they contain at least as many downstream and upstream ports as any primary CMTS in the system.

Each primary CMTS transceiver 120 is connected to an interface adapter 250. Each interface adapter 250 includes a directional coupler 140 connected between a communication port of its associated primary CMTS transceiver 120 and a corresponding communication port of the interface adapter 250. For example, a directional coupler 140 is connected between an upstream communication port 122₁ of the primary CMTS transceiver 120₁ and its associated upstream communication port 252₁ of the interface adapter 250₁.

Each directional coupler 140 is further connected to a switch module 260. Such connection may be made through an optional intermediary device, designated in FIG. 2 as mezzanine board 261. The switch module 260 acts as a multiplexer, selectively connecting a directional coupler 140 with an associated communication port of the backup CMTS transceiver 130. For one embodiment, the switch module 260 includes an upstream switching module 262 selectively connecting an upstream communication port 132 of the backup CMTS transceiver 130 to a directional coupler 140 associated with the corresponding upstream communication port 122 of a primary CMTS transceiver 120. There is one upstream switching module 262 for each upstream communication port 132 of the backup CMTS transceiver 130. For a further embodiment, the switch module 260 further includes a downstream switching module 264 selectively connecting a downstream communication port 134 of the backup CMTS transceiver 130 to a directional coupler 140 associated with the corresponding downstream communication port 124 of a primary CMTS transceiver 120. There is one downstream switching module 264 for each downstream communication port 134 of the backup CMTS transceiver 130.

To maintain near unity gain when using the backup CMTS transceiver 130, the signal path between the backup CMTS transceiver 130 and the directional couplers 140 will need to be amplified. Because the directional couplers 140 are configured to have relatively low losses in the primary signal path, preferably on the order of 1.5 dB or less, losses between the backup CMTS transceiver 130 and the directional couplers 140 will generally be relatively high, e.g., 7 dB or more. Thus, to insure transparency to the end users when a switch is made to the backup CMTS transceiver 130, this signal path must compensate for such losses. For one embodiment, an amplifier 263 is connected between each upstream switching module 262 and its associated upstream communication port 132. For a further embodiment, an amplifier 265 is connected between each downstream switching module 264 and its associated downstream communication port 134. While the amplifiers 262 and 264 could be connected on the opposite sides of the switching modules 262 and 264, respectively, it is more economical to have a one-to-one relationship with the communication ports of the backup CMTS transceiver 130 than with all of the primary CMTS transceivers 120.

The backup CMTS transceiver 130 may be connected to the switch modules 262/264 through an interface adapter 255. Although the interface adapter 255 could have the same configuration as the interface adapters 250, there is no need for additional directional couplers connected to the backup CMTS transceiver 130 through the interface adapter 255.

The inherent isolation between ports of the directional couplers 140 in the primary CMTS transceiver signal paths adds to the performance of the CMTS 110. Potential crosstalk between primary CMTS transceivers 120 through imperfections of the switching modules 262/264 is minimized. Additionally, when a primary CMTS transceiver 120 is removed for maintenance, the effect on the system performance when the backup CMTS transceiver 130 is active is negligible.

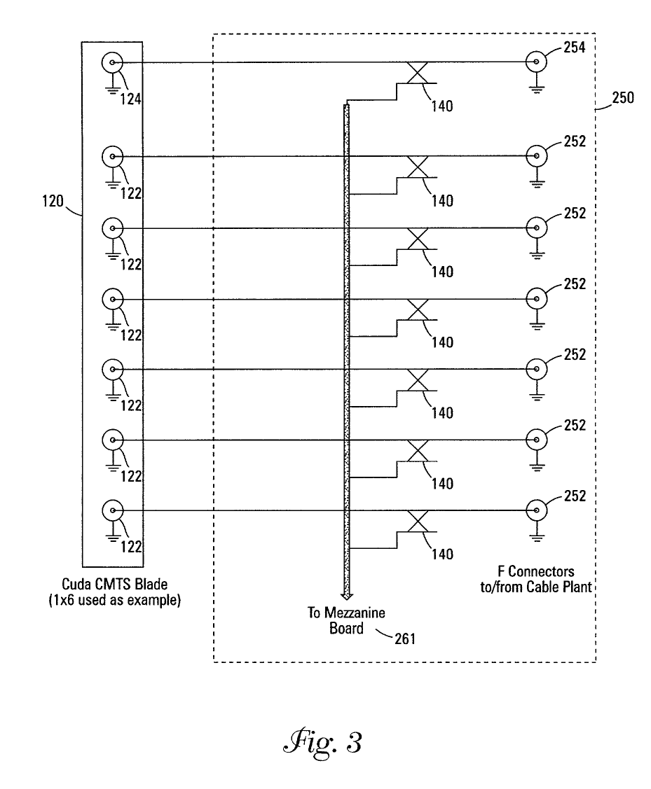

FIG. 3 is a schematic showing additional detail of a primary CMTS transceiver 120 and its associated interface adapter 250. The primary CMTS transceiver 120 depicted in FIG. 3 includes one downstream communication port 124 and six upstream communication ports 122. Each communication port of the primary CMTS transceiver 120 is connected to it associated communication port of the interface adapter 250 through a directional coupler 140. For one embodiment, the directional couplers exhibit −1.5 dB in the downstream direction and −1.5 dB in the upstream direction for the primary signal path. For a further embodiment, the directional couplers exhibit −10 dB in the downstream direction and −10 dB in the upstream direction for the backup signal path, i.e., the path between the directional couplers 140 and the backup CMTS transceiver 130. Directional couplers 140 are generally 4-port devices. These ports are commonly referred to as an “in” port, an “out” port, a “forward coupled” port and a “reverse coupled” port. A signal in the primary signal path passes from the “in” port to the “out” port with relatively low loss. A signal in the backup signal path passes from the “in” port to the “forward coupled” port attenuated by the coupling value of the directional coupler. The unconnected port of each directional coupler 140, i.e., the “reverse coupled” port, is preferably resistance terminated. For one embodiment, a 75 ohm resistance is used to terminate each unconnected port.

Testing of the backup CMTS transceiver 130 is also possible with this scheme without interrupting primary CMTS service and without removing the backup CMTS transceiver 130 from the CMTS 110. Through the use of additional directional couplers in the backup signal path (not shown in FIG. 2 or 3), internally generated test signals can be detected and measured. By exercising the switch modules 262/264, the service availability of the switches can be determined by detecting the test signals. This process in non-invasive to the primary CMTS transceiver signal paths.

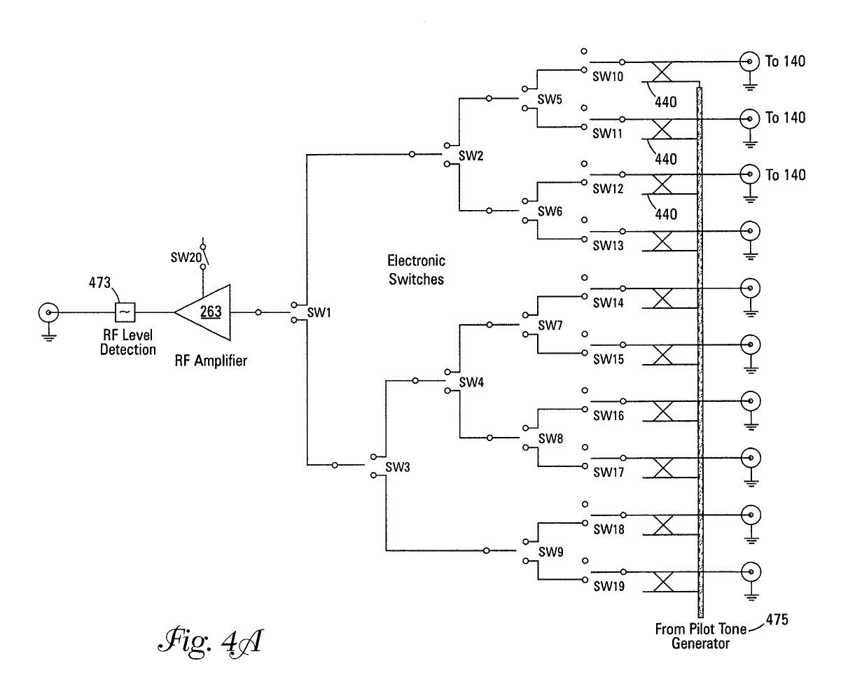

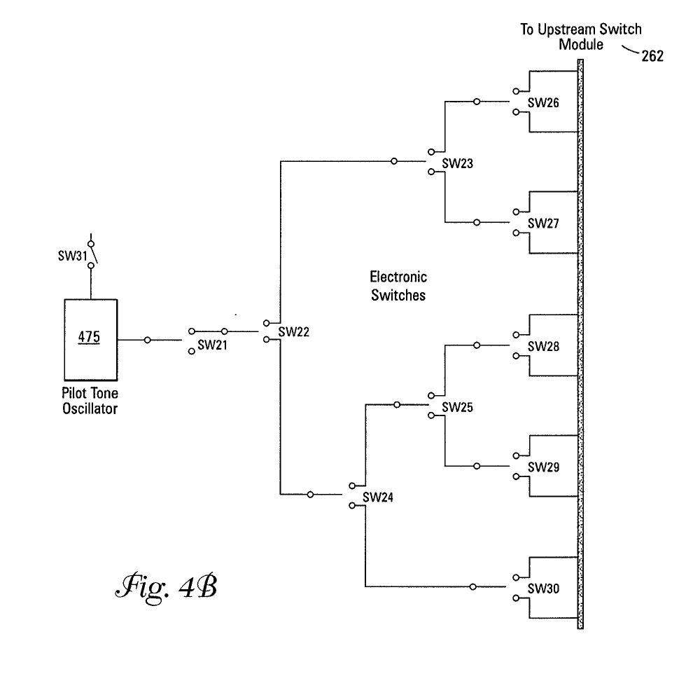

FIGS. 4A-4B are schematics of an upstream switch module 262 including optional directional couplers 440 and pilot tone generator 475 for use in testing of the CMTS 110. The upstream switch module 262 may further include circuitry 473 for detecting the RF level of the backup signal path. Such can be used to assure that the RF level is within operating limits when the intended switches are activated.

The upstream switching module 262 includes a plurality of switches, or switchin matrix, SW1-SW19 of FIG. 4A for selectively connecting an upstream communication port of the backup CMTS transceiver 130 to its associated directional coupler 140 through a directional coupler 440. Switches SW1-SW19 of FIG. 4A are preferably RF switches or relays. An additional port of each directional coupler 440 is selectively connected to pilot tone generator 475, such as through electronic switches SW21-SW30 of FIG. 4B. The unconnected port of each directional coupler 440 is preferably resistance terminated.

The pilot tone generator 475 may be selectively activated, such as through switch SW31. Similarly, as the amplifier 263 is not needed unless the backup CMTS transceiver 130 is active, it may be selectively activate, such as through switch SW20. The pilot tone generator 475 permits testing of the receive portion of the backup CMTS transceiver 130, as well as the switches and amplifier that pass the upstream signals to the backup CMTS transceiver 130. For one embodiment, the pilot tone generator 275 resides in the backup CMTS transceiver 130.

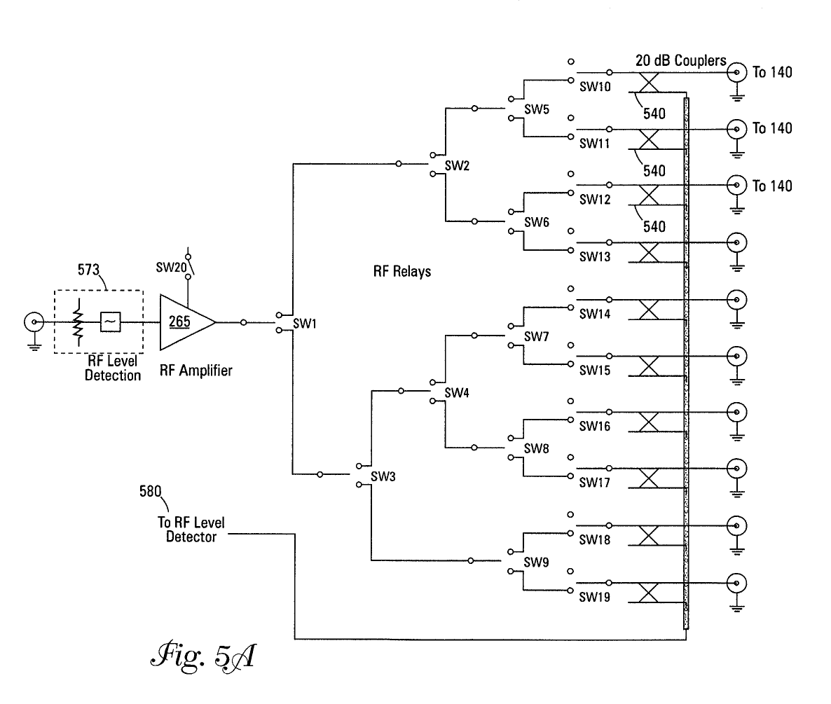

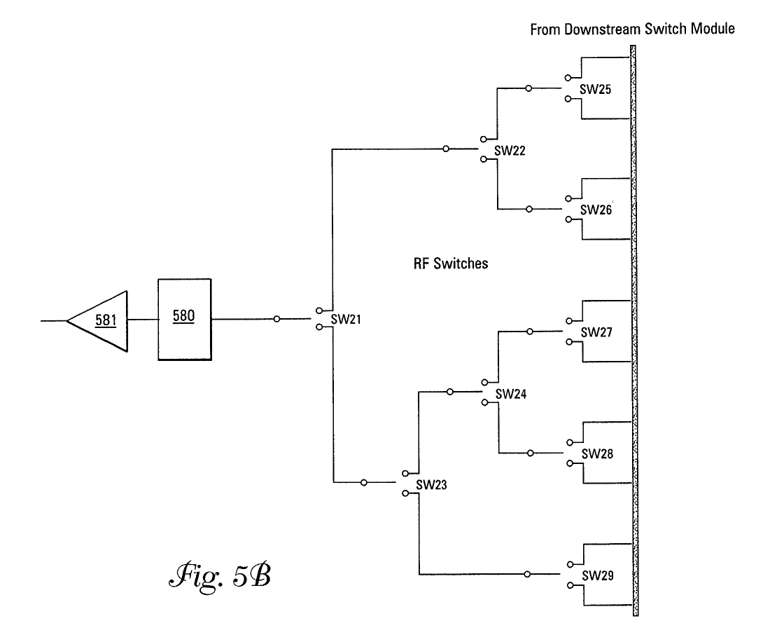

FIGS. 5A-5B are schematics of a downstream switch module 264 including optional directional couplers 540 and RF level detector 580 for use in testing all components in the signal path starting at the transmit portion of the Backup CMTS transceiver 130 and ending with the RF level detector 473 in the upstream switch module 262. The downstream switch module 264 may further include circuitry 573 for detecting the RF level of the backup signal path. Such can be used to assure that the RF level is within operating limits when the intended switches are activated. The RF level detector 580 may be used to adjust the gain of the amplifier 265 in order to provide near unity gain in the backup signal path. For one embodiment, the directional couplers 540 are 20 dB couplers.

The downstream switching module 264 includes a plurality of switches SW1-SW19 of FIG. 5A for selectively connecting a downstream communication port of the backup CMTS transceiver 130 to its associated directional coupler 140 through a directional coupler 540. An additional port of each directional coupler 540 is selectively connected to RF level detector 580, such as through switches SW21-SW29 of FIG. 5B. The unconnected port of each directional coupler 540 is preferably resistance terminated. An additional amplifier 581 may be connected to the RF level detector 580 for use in bringing the signal power to a desired level.

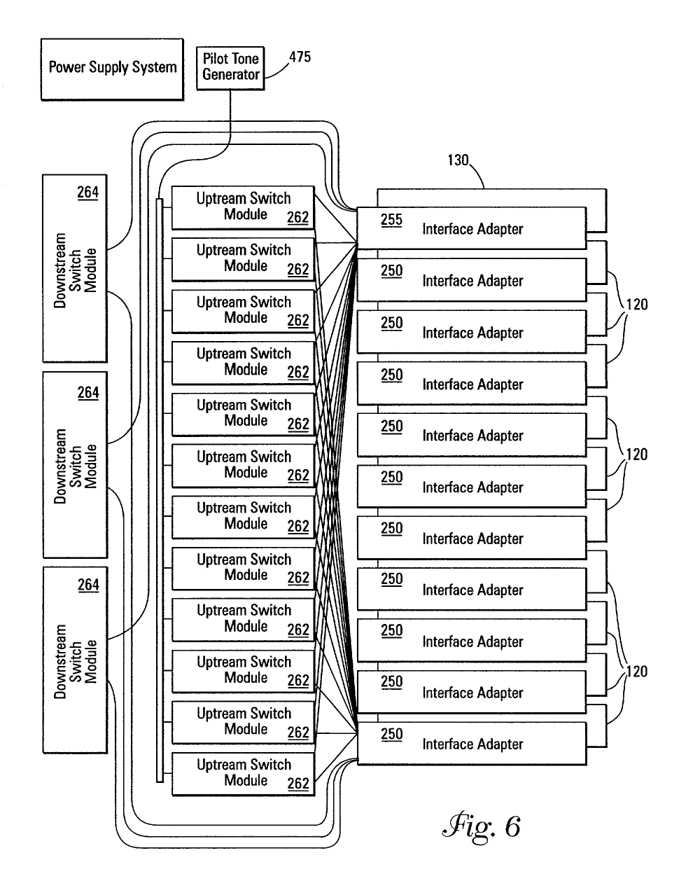

FIG. 6 is a block diagram of a CMTS 110 showing connectivity of various components. For clarity, signal lines are shown only for the first primary CMTS transceiver 120 and for the backup CMTS transceiver 130. Identical signal lines may run from each primary CMTS transceiver 120 to the upstream switch modules 262 and the downstream switch modules 264. Note that the CMTS 110 of FIG. 6 is depicted as having ten primary CMTS transceivers 120 and one backup CMTS transceiver 130, with each CMTS transceiver having twelve upstream communication ports and three downstream communication ports.

The logic for determining when to switch between use of a primary CMTS transceiver in a first operation mode, e.g., a normal operation mode, and use of a backup CMTS transceiver in a second operation mode, e.g., a failure mode, is outside the scope of this invention. In general, however, when failure of a primary CMTS transceiver is detected, the switch module is provided with the appropriate logic or control signals to couple the backup CMTS transceiver to the directional couplers associated with the failed primary CMTS transceiver. Repair or replacement of the failed primary CMTS transceiver may then be accomplished during the second operation mode without disturbing the signal path to the backup CMTS transceiver. Upon repair or replacement of the failed primary CMTS transceiver, the CMTS can be returned to its first operation mode.

### CONCLUSION

Cable modem termination systems (CMTS) have been described to facilitate redundancy without the need for active components, e.g., switches or amplifiers, in the primary signal path, and with a low signal loss in the primary signal path incurred by the redundancy components. Such elimination of active components in the primary signal path is made possible through the use of passive directional couplers in the primary signal path.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A cable modem termination system (CMTS), comprising:
two or more primary CMTS transceivers, each for transceiving communications through a primary signal path;
a plurality of directional couplers connected to the primary CMTS transceivers in the primary signal path; and
one backup CMTS transceiver selectively connected to the plurality of directional couplers outside of the primary signal path.

2. The CMTS of claim 1, further comprising a switch module connected between the backup CMTS transceiver and the primary CMTS transceivers for selectively connecting the backup CMTS transceiver to the plurality of directional couplers.

3. The CMTS of claim 2, wherein the backup and primary CMTS transceivers each further comprise one or more upstream communication ports and one or more downstream communication ports, wherein each communication port of the primary CMTS transceivers is connected to one of the plurality of directional couplers, wherein the switch module further comprises an upstream switch module associated with each upstream communication port of the backup CMTS transceiver for selectively connecting that upstream communication port to a directional coupler associated with a corresponding upstream communication port of one of the primary CMTS transceivers, and wherein the switch module further comprises a downstream switch module associated with each downstream communication port of the backup CMTS transceiver for selectively connecting that downstream communication port to a directional coupler associated with a corresponding downstream communication port of one of the primary CMTS transceivers.

4. The CMTS of claim 3, wherein each switch module further comprises an amplifier connected between its associated communication port of the backup CMTS transceiver and the associated communication ports of the primary CMTS transceivers.

5. The CMTS of claim 4, wherein each switch module further comprises RF level correction circuitry.

6. The CMTS of claim 3, further comprising:
a plurality of first additional directional couplers, with one first additional directional coupler connected between a pilot tone generator and each directional coupler of the plurality of directional couplers associated with an upstream communication port of a primary CMTS transceiver.

7. The CMTS of claim 6, further comprising:
a plurality of second additional directional couplers, with one second additional directional coupler connected between an RF detector and each directional coupler of the plurality of directional couplers associated with a downstream communication port of a primary CMTS transceiver.

8. A redundancy system for a cable modem termination system (CMTS), comprising:
a first directional coupler comprising a first port for connecting to a communication line, a second port connected to a first CMTS transceiver for transceiving communications on the communication line in a first operation mode and a third port selectively connected to a backup CMTS transceiver for transceiving communication on the communication line in a second operation mode.

9. The redundancy system of claim 8, wherein the first directional coupler further comprises a fourth port and wherein the fourth port is resistance terminated.

10. The redundancy system of claim 8, wherein the first directional coupler is configured to have relatively low loss in a first signal path between the communication line and the first CMTS transceiver and to have relatively high loss in a second signal path between the communication line and the second CMTS transceiver.

11. The redundancy system of claim 10, wherein the first directional coupler is configured to exhibit approximately −1.5 dB in a downstream direction of the first signal path, approximately −1.5 dB in an upstream direction of the first signal path, approximately −10 dB in the downstream direction of a second signal path, and approximately −10 dB in the upstream direction of the second signal path.

12. The redundancy system of claim 8, further comprising a switch module connected between the second CMTS transceiver and the first directional coupler for selectively connecting the second CMTS transceiver to the third port of the first directional coupler or to a third port of another first directional coupler connected to another CMTS transceiver.

13. The redundancy system of claim 12, further comprising an amplifier connected between the switch module and the second CMTS transceiver for amplifying the communication between the second CMTS transceiver and the first directional coupler when in the second operation mode.

14. The redundancy system of claim 13, further comprising a second directional coupler connected between the amplifier and the first directional coupler and comprising a first port selectively connected to the amplifier through the switch module, a second port connected to the third port of the first directional coupler, and a third port connected to an RF detector.

15. The redundancy system of claim 13, further comprising a second directional coupler connected between the amplifier and the first directional coupler and comprising a first port selectively connected to the amplifier through the switch module, a second port connected to the third port of the first directional coupler, and a third port connected to a pilot tone generator.

16. A cable modem termination system (CMTS), comprising:
at least one primary CMTS transceiver, each primary CMTS transceiver comprising one or more upstream communication ports for communication with subscriber equipment and one or more downstream communication ports for communication with a head end;
at least one backup CMTS transceiver, each backup CMTS transceiver comprising one or more upstream communication ports for communication with the subscriber equipment and one or more downstream communication ports for communication with the head end; and
a plurality of directional couplers, with a directional coupler connected to each communication port of the primary CMTS transceivers;
wherein each communication port of a backup CMTS transceiver is selectively connected to a directional coupler of a corresponding communication port of at least one primary CMTS transceiver.

17. The CMTS of claim 16, further comprising one backup CMTS transceiver and a plurality of primary CMTS transceivers.

18. The CMTS of claim 17, wherein the plurality of primary CMTS transceivers comprises between six and ten primary CMTS transceivers.

19. The CMTS of claim 16, wherein each directional coupler is configured to have relatively low loss in a first signal path for communication with a communication port of a primary CMTS transceiver and to have relatively high loss in a second signal path for communication with a communication port of a backup CMTS transceiver.

20. The CMTS of claim 19, wherein the first signal path is across a first and second port of each directional coupler and wherein the second signal path is across the first and a third port of each directional coupler.

21. The CMTS of claim 20, wherein the second port of each directional coupler is opposite the first port of that directional coupler and wherein a fourth port of each directional coupler is resistance terminated.

22. The CMTS of claim 19, wherein each directional coupler is configured to exhibit approximately −1.5 dB in a downstream direction of the first signal path, approximately −1.5 dB in an upstream direction of the first signal path, approximately −10 dB in the downstream direction of a second signal path, and approximately −10 dB in the upstream direction of the second signal path.

23. The CMTS of claim 17, further comprising a switch module connected between the backup CMTS transceiver and the primary CMTS transceivers for selectively connecting the backup CMTS transceiver to the plurality of directional couplers.

24. The CMTS of claim 23, wherein the switch module further comprises an upstream switch module associated with each upstream communication port of the backup CMTS transceiver for selectively connecting that upstream communication port to a directional coupler associated with a corresponding upstream communication port of one of the primary CMTS transceivers, and wherein the switch module further comprises a downstream switch module associated with each downstream communication port of the backup CMTS transceiver for selectively connecting that downstream communication port to a directional coupler associated with a corresponding downstream communication port of one of the primary CMTS transceivers.

25. The CMTS of claim 24, wherein each switch module further comprises an amplifier connected between its associated communication port of the backup CMTS transceiver and the associated communication ports of the primary CMTS transceivers.

26. The CMTS of claim 24, wherein each upstream switch module further comprises an amplifier connected between its associated upstream communication port of the backup CMTS transceiver and the associated upstream communication ports of the primary CMTS transceivers, and a switching matrix interposed between the associated upstream communication ports of the primary CMTS transceivers and the amplifier.

27. The CMTS of claim 26, further comprising a plurality of additional directional couplers connected to a signal path between the associated upstream communication ports of the primary CMTS transceivers and the switching matrix, wherein the plurality of additional directional couplers are further connected to a pilot tone generator.

28. The CMTS of claim 24, wherein each downstream switch module further comprises an amplifier connected between its associated downstream communication port of the backup CMTS transceiver and the associated downstream communication ports of the primary CMTS transceivers, and a switching matrix interposed between the associated downstream communication ports of the primary CMTS transceivers and the amplifier.

29. The CMTS of claim 28, further comprising a plurality of additional directional couplers connected to a signal path between the associated downstream communication ports of the primary CMTS transceivers and the switching matrix, wherein the plurality of additional directional couplers are further connected to an RF level detector.

30. The CMTS of claim 24, wherein each switch module further comprises RF level correction circuitry.

31. A method of providing redundancy in a cable modem termination system (CMTS), comprising:
passing communications through a directional coupler to a primary CMTS transceiver during a first operation mode; and
passing the communications through the directional coupler to a backup CMTS transceiver during a second operation mode.

32. The method of claim 31, further comprising:
testing the backup CMTS transceiver during the first operation mode without disturbing the communications.

33. The method of claim 32, further comprising:
testing the backup CMTS transceiver during the first operation mode without removing the backup CMTS transceiver from the CMTS.

34. The method of claim 31, further comprising:
entering the second operation mode upon detecting a failure of the primary CMTS transceiver.

35. A method of operating a cable modem termination system (CMTS), comprising:
communicating with one or more primary CMTS transceivers across a primary signal path during a first operation mode, wherein each primary CMTS transceiver has one or more upstream communication ports for communication with subscriber equipment and one or more downstream communication ports for communication with a head end, and wherein a directional coupler is connected between each upstream communication port and the subscriber equipment and between each downstream communication port and the head end;
detecting a failure of one of the primary CMTS transceivers; and
entering a second operation mode wherein communication with the failed primary CMTS transceiver is routed through a backup CMTS transceiver through the directional couplers associated with the failed primary CMTS transceiver.

36. The method of claim 35, further comprising:
amplifying the communication through the backup CMTS transceiver during the second operation mode.

37. The method of claim 36, wherein the communication through the backup CMTS transceiver is amplified to compensate for losses through the directional coupler to create a signal with near unity gain.

38. The method of claim 37, further comprising:
detecting a signal level of the communication through the backup CMTS transceiver; and
adjusting the amplification based on the detected signal level to create the signal with near unity gain.

39. The method of claim 35, further comprising:
testing the backup CMTS transceiver during the first operation mode without disturbing the communications with the primary CMTS transceivers.

40. The method of claim 39, further comprising:
testing the backup CMTS transceiver during the first operation mode without removing the backup CMTS transceiver from the CMTS.
